(19) United States
(12) Patent Application Publication
(10) Pub. No.: US 2018/0373819 A1
(43) Pub. Date: Dec. 27, 2018

(54) POSITION-DETERMINISTIC MACHINE AND METHODS FOR NONDETERMINISTIC COMPUTING

(71) Applicant: Aizhong Li, Ottawa (CA)

(72) Inventors: Aizhong Li, Ottawa (CA); Yufu He, Ottawa (CA)

(73) Assignees: Dr. Aizhong Li, Ottawa (CA); Yufu He, Ottawa (CA)

(21) Appl. No.: 15/630,967

(22) Filed: Jun. 23, 2017

(51) Int. Cl. G06F 17/50; G06N 7/00

(52) U.S. Cl. CPC G06F 17/5009; G06N 7/005

(57) ABSTRACT

In the disclosed position-deterministic machine (PDM) and its simulation methods, a user problem to be solved is represented as a special kind of nondeterministic Turing machine, called PDM, with an input X to it. Deterministic methods of using deterministic components and recursive relations for the simulation of a PDA on an input X are disclosed. The disclosed methods decrease deterministic computational time complexity from 2^{T(n)} currently to nT(n) in the present invention for a PDM of nondeterministic computational time complexity T(n) on an input X of length n.

### TECHNICAL FIELD

The present invention relates to a nondeterministic computing apparatus, or more specifically relates to deterministic methods for the efficient simulation of nondeterministic computation using a deterministic computing apparatus or components.

### BACKGROUND ART

As known in the prior art, in general, there are two kinds of computing apparatuses, invented and classified by A. M. Turing: deterministic computing apparatuses and nondeterministic computing apparatuses. A deterministic computing apparatus, such as a digital computer, is modeled after a deterministic Turing machine (DTM), which has a single sequence of primitive operations for a given input. A nondeterministic computing apparatus is modeled after a nondeterministic Turing machine (NTM), which may have multiple ‘simultaneous’ or ‘parallel’ sequences of primitive operations for a given input. A DTM is a degeneration of a NTM. There are various NP-complete problems in practice, such as the satisfiability problem, the traveling salesman problem, and the integer linear programming problem, which can be solved in polynomial time by a NTM. If any of them is solved by a DTM in polynomial time, then all of them can be solved by a DTM in polynomial time. Currently there are two approaches to nondeterministic computing apparatuses:
1. A probabilistic or physically nondeterministic computing apparatus to improve the performance at the loss of correctness. But in general, a NTM cannot be implemented physically because it may require infinite physical memory or storage. At the same time, the halting problem is undecidable. There are technical difficulty or even inability to control nondeterministic components and detect the results. No such computing apparatus is available in market for everyday use like a digital computer. For example:
   U.S. Pat. No. 6,463,422: “Probabilistic computing methods and apparatus”;
   U.S. Pat. No. 7,400,282: “Quantum turing machine”;
   U.S. Pat. No. 7,130,093: “Optical implementation of bounded nondeterministic Turing Machines”;
   U.S. Pat. No. 5,843,661: “Method for Construction Universal DNA based Molecular Turing Machine”;
   U.S. Pat. No. 6,266,569: “Method and System of Computing Similar to a Turing Machine”.
2. A simulated nondeterministic computing apparatus by use of a deterministic apparatus or components to improve the performance of some specific problems on some specific inputs in terms of heuristics. The heuristic is not complete. The time complexity is exponential at worst. An efficient and complete method is still in need. For example:
   U.S. Pat. No. 7,577,625: “Handling of Satisfaction and Conflicts in a Quantified Boolean Formula Solver”;
   U.S. Pat. No. 7,992,113: “Methods and Apparatus for Decision Making in Resolution based SAT-solvers”; and
   U.S. Pat. No. 7,860,814: “System and Method for Providing a User-selected Best Solution to an NP-complete Scheduling Problem”.
   U.S. Pat. No. 5,678,055: “Method and Device for Generating Groebner Bases to Reduce Memory Usage and Increase Computing Speed”.
   Wen-Tsun Wu's method is more special and more efficient in practice in elementary geometry than Buchberger's general Groebner Bases method, where polynomial equations are arranged into row echelon (or triangular) form, with reference made to Cox, D., J. Little and D. O'shea [2007]: IDEAS, VARIETIES, AND ALGORITHMS
      An Introduction to Computational Algebraic Geometry and Commutative Algebra, Springer.
   U.S. Pat. No. 8,577,825 B2: “System, Method and Device for Solving Problems in NP without Hyper-polynomial Cost”.
   U.S. patent application Ser. No. 14/866,995: “Apparatus and Methods for Nondeterministic Computing”, with a time complexity of O(T¹²(n) log T(n)), which is difficult to use.

In summary, an efficient method is needed for the simulation of a NTM. It relates the nature of computation. To avoid the undecidable halting problem, rather than simulating a NTM in general, the present invention simulates a simplified position-deterministic NTM more efficiently without loss of expressiveness. The simplification yields an efficient simulation method as disclosed herein.

### DISCLOSURE OF INVENTION

### The Technical Problem

The purpose of the present invention is to provide an efficient realization of nondeterministic computations to solve practical problems. With reference made to A. V. Aho, J. E. Hoperoft and J. D. Ullman [1974]: The Design and Analysis of Computer Algorithms, Addison-Wesley; without limiting, throughout the present invention, a single-tape position-deterministic machine with an input is adopted as the representation of a user's problem, where a PDM is a simplified nondeterministic Turing machine (NTM). PDM's have the same expressive power of NTM's. A PDM only changes its tape head direction at the tape ends. A position-deterministic machine (PDM) is formally denoted by 9-tuple PDM:=(Q_{L}, Q_{R}, Y, Σ, δ, q_{q}, Q_{f}, └, ┘) for the purpose of programmatic verification, where
Q:=Q_{L}∪Q_{R} satisfying Q_{L}∩Q_{R}=ϕ is a finite set of states, each of which may represent a state of a physical object; L and R stand for one cell shift in direction left and right, respectively.
qₛ, in Q_{L}, is the designated start state, or in general is designated to a set of start states.
Q_{f}, a subset of Q, is a set of designated accepting states.
Y is a finite set of tape symbols, each of which may represent a physical object. Left endmarker └ and right endmarker ┘ are two specially designated tape end symbols. Some designated tape symbols may be for internal use only, e.g., for workspace initialization.
Σ, a subset of Y, is a set of input symbols, each of which may represent a physical object for user's input. The left endmarker └ and the right endmarker ┘ are not in Σ.
δ, is a transition function mapping a condition in (Q−Q_{f})×Y to a set of choices (or operations) in 2^{Q×Y}. Function δ is also a relation, δ⊆(Q−Q_{f})×Y×Q×Y. For a choice (q, y)∈δ(p, x), the tape head shifts one cell in direction left if q∈Q_{L}, otherwise, shifts one cell in direction right. For a choice c, let c·q and c·y denote its state and symbol, respectively. Let I:=Y−{└, ┘}, function δ degenerates, in comparison to a NTM in general, as follows: for all q_{L}∈Q_{L}, for all qᵣ∈Q_{R}, for all x∈I,

δ(q_{L},└)⊆Q_{R}×{└} and δ(q_{R},x)⊆Q_{R}×I and δ(q_{R},┘)⊆Q_{L}×{┘} and δ(q_{L},x)⊆Q_{L}×I.
Function δ may represent the rules of operations and/or relationships of physical objects.

In one exemplary embodiment of the present invention, using Java as the programming language, a PDM is stored as a Java class encapsulates the following instances:
1. Q, Q_{L}, and Q_{R} are TreeSet<State> instances, where class State encapsulates a String or an Integer;
2. Y is a TreeSet<Symbol> instance, where class Symbol encapsulates a String or a Character;
3. I is another TreeSet<Symbol> instance;
4. qₛ is a special State instance;
5. Q_{f} is another TreeSet<State> instance;
6. δ is a Hashtable<Condition, <TreeSet<Choice>>> instance, where
   Class Condition encapsulates a State instance and a Symbol instance;
   Class Choice encapsulates a State instance and a Symbol instance.

An input X to a PDM is represented by an array of Symbol, including specially designated workspace optionally in the array. Therefore both a PDM and an input X are stored in a machine-readable format as a user's problem specification. The present invention includes optional transformation of user's problems in other format into the above-defined format and/or transforms the disclosed methods to process the user's problem directly under the user's terminologies.

The problem of the present invention is to decide whether a PDM accepts an input X. The problem can be restated as whether a physical object in its initial state can be transformed into another physical object (including the same object) in an accepting state by one or more sequences of primitive physical operations. If the input is accepted, the problem may further include finding one or more primitive operation sequences leading the initial state to an accepting state at user's preference, especially in optimization problem solving. In such a case, a unit weight/cost is assigned to a primitive operation/move; otherwise a non-unit complex operation/move is split into multiple primitive operations/moves of unit weight/cost. The present invention finds the least cost sequence(s) of primitive operations upon acceptance.

### Technical Solution to the Problem

The present invention provides physical embodiments and methods to solve the said problem of the present invention.

With reference made to Codd, E. F. 1970. “A Relational Model of Data for Large Shared Data Banks”. CACM 13 (6): 377-387 and Gödel K. 1931. “On formally undecidable propositions of Principia Mathematica and related systems” in J. von Heijenoort (ed.), From Frege to Gödel, Harward University Press, page 596-617, 1967, the present invention defines and utilize a recursive relations to represent 2^{T(n)} nondeterministic computations of a PDM on an input X of length n in a space of T(n) trichoices as follows.

Let the time complexity of a PDM be T(n) for an input X of length n, including enough workspace allocated optionally. The range of time T:=[0, T(n)−1]. In an exemplary embodiment, the tape head position at time t on input X,

h(t, x) :=

| | | |
|---|---|---|
| ▪ | t % (2π) | if t∈ [0, π], |
| ▪ | π − (t % 2π), | otherwise; |

where π := n+1.

The last time, when cell h(t, x) was written before time t, was

w(t, x) :=

| | | |
|---|---|---|
| ▪ | undefined | if t∈ [0, π], |
| ▪ | t − 2π | if t∉ [0, π] and t%π=0, |
| ▪ | t − 2(t%π) | otherwise. |

The next time, when cell h(t, x) will be read after time t, will be

r(t,x)t+2(π−t % π).

In general, h(t, x) can be any “simple” function of time t and input X such that h(t, x), w(t, x), and r(t, x) are “easy” to calculate in commonsense with respect to time and space complexities.

Let the input X:=X₁ . . . Xₙ, in E*, of length n, and let the initial tape contents be X₀X₁ . . . XₙXₙ₊₁ from the leftmost to the rightmost on the tape, where X₀:=└ and Xₙ₊₁:=┘. Optionally workspace may be allocated in between the two end markers.

A t-computation (or simply, a computation, without time complexity t) of a PDM on an input X is such a time sequence of choices c₀c₁ . . . cₜ₋₁ that

| | | |
|---|---|---|
| ▪ | c₀∈ δ(qₛ, └) | for i=0, |
| ▪ | cᵢ∈ δ(cᵢ₋₁, Xᵢ) | for i∈ [1, π], |
| ▪ | cᵢ∈ δ(cᵢ₋₁, c_{w(i, X)}·y) | for i∈ [π, t−1]. |

A PDM accepts an input X if qₛ∈Q_{f} or there exists a t-computation c₀c₁ . . . cₜ₋₁ such that cₜ₋₁·q∈Q_{f}.

From here on, a choice cᵢ is extended with its selection time i and let cᵢ·t denote its selection time i.

For a PDM on an input X, taken from an extended t-computation c₀c₁ . . . cₜ₋₁, its i-th trichoice (c_{w(i,X)}, cᵢ₋₁, cᵢ) represents both a move and the relationships among moves (or choices) by using c_{w(i,X)} and cᵢ₋₁ as foreign keys referencing to previously defined moves in the formats of (w, p, c_{c-1}) and (w′, p′, c_{w(i,X)}). If i=0, then cᵢ₋₁:=null. If i∈[0, π], then c_{w(i,X)}:=null. The last enclosed choice cᵢ is being declared in trichoice (c_{w(i,X)}, cᵢ₋₁, cᵢ) in the context of the two previous choices c_{w(i,X)} and cᵢ₋₁ referenced by foreign keys. Choices c_{w(i,X)} and cᵢ₋₁ are used by choice c in the enclosing t-computation.

For a PDM on an input X, the O(2^{T(n)}) computations are broken apart into a self-referencing relation R:={(c_{w(i,X)}, cᵢ₋₁, cᵢ)/(c_{w(i,X)}, cᵢ₋₁, cᵢ) is the i-th trichoice of a t-computation c₀c₁ . . . cₜ₋₁ where i∈[0, t−1] and t∈[1, T(n)]}.

With reference made to Aizhong Li [2017]: The Recursive Relational Model of Computations and its Application to NP Problems, submitted to Science Advances magazine on Jun. 19, 2017, without publication, the size of R is O(T(n)) trichoices. The time properties in foreign keys c_{w(i,X)} and cᵢ₋₁ are redundant and can be eliminated by normalization without affecting the nature of the present invention. They are kept for readability.

With reference made to the said Aizhong Li [2017], it is proved that, for a PDM on an input X, the computations are exactly the computations composed from R. A t-computation c₀c₁ . . . cₜ₋₁ is called being composed from R if (c_{w(i,X)}, cᵢ₋₁, cᵢ)∈R for all i∈[0, t−1]. A PDM on an input X can be simulated by the enumeration of trichoices in R. Because the definition of R involves the enumeration of O(2^{T(n)}) computations, an efficient method to calculate R is required. In the present invention, relation R is partitioned by time t into {(w, p, c)/(w, p, c)∈R and c·t=t} for t∈[0, T(n)−1] and then the partitions are recursively calculated efficiently, in an exemplary embodiment of the present invention, as follows.

R₀:={(null,null,c₀)/c₀=(0,q,└)̂(q,└)∈δ(qₛ,└)}.

Relation Rₜ₊₁ is calculated from a portion of relations R₀, R₁, . . . , Rₜ. To do so, temporary relations Rₖ(cₜ), Rₖ₊₁(cₜ) . . . , Rₜ(cₜ) are calculated when t+1∉[0, π], where choice cₜ·t=t and there exists w and p such that (w, p, cₜ)∈Rₜ, and k:=MAX(w(t+1, X)−1, 0) for better performance.

In an exemplary embodiment, the specific steps are listed as follows to delete choices unused in any (t+1)-computation composed from R₀(cₜ)∪R₁(cₜ)∪ . . . ∪Rₜ(cₜ):

| | |
|---|---|
| [1] | Rₜ(cₜ) := Rₜ − {(w, p, c) / (w, p, c)∈Rₜ \hat{ } c≠cₜ}; |
| [2] | for i := t−1; i ≥ k; i := i +1 |

| | |
|---|---|
| [3] | Rᵢ(cₜ) := Rᵢ; |

| | |
|---|---|
| [4] | for i := t−1; i ≥ k; i := i +1 |

| | |
|---|---|
| [5] | Rᵢ(cₜ) := Rᵢ(cₜ) − {(w, p, cᵢ) / (w, p, cᵢ)∈Rᵢ(cₜ) \hat{ } !∃_{w′,} _{c}_{ᵢ₊₁}(w′, cᵢ, cᵢ₊₁)∈Rᵢ₊₁(cₜ) }; |
| [6] | If r(i, X) ≤ t |

| | |
|---|---|
| [7] | Rᵢ(cₜ) := Rᵢ(cₜ) − {(w, p, cᵢ) / (w, p, cᵢ)∈Rᵢ(cₜ) \hat{ } !∃_{c}_{_{r(i, X)−1}}_{, c}_{_{r(i, X)}}(cᵢ, c_{r(i ,X)-1}, c_{r(i ,X)})∈R_{r(i ,X)}(cₜ) }; |
| [8] | Rᵢ₊₁(cₜ) := Rᵢ₊₁(cₜ) − {(w″, cᵢ, cᵢ₊₁) / (w″, cᵢ, cᵢ₊₁)∈Rᵢ₊₁(cₜ) \hat{ } !∃ _{w, p}(w, p, cᵢ)∈Rᵢ(cₜ) }. |

After the above deletions of unused choices, every enclosed choice declared in Rᵢ(cₜ) for i∈[k, t] is used in at least one (t+1)-computation ending at cₜ and composed from R₀(cₜ)∪R₁(cₜ)∪ . . . ∪Rₜ(cₜ), and composed from R₀ ∪R₁ ∪ . . . ∪Rₜ, and composed from R ultimately. Therefore, Rₜ₊₁ is calculated, in an exemplary embodiment, by the following specific steps:

| | |
|---|---|
| [1] | Rₜ₊₁ := ϕ; |
| [2] | for each (w″, p″, cₜ)∈Rₜ |
| [3] | if t+1∈[0, π] |

| | |
|---|---|
| [4] | Rₜ₊₁ := Rₜ₊₁ ∪ {(null, cₜ, cₜ₊₁) / cₜ₊₁·t = t+1 \hat{ } (cₜ₊₁·q, cₜ₊₁·y)∈δ(cₜ·q, Xₜ₊₁)}; |

| | |
|---|---|
| [5] | else |

| | |
|---|---|
| [6] | Rₜ₊₁ := Rₜ₊₁ ∪ {(w, cₜ, cₜ₊₁) / ( w″, p″, w)∈R_{w(t+1,X)}(cₜ) \hat{ } cₜ₊₁·t = t+1 \hat{ } (cₜ₊₁·q, cₜ₊₁·y)∈δ( cₜ·q, w·y)}. |

With reference made to the said Aizhong Li [2017], it is proved that Rₜ={(w, p, c)/(w, p, c)∈R and c·t=t} for any time t.

Because R=R₀ ∪R₁ ∪ . . . ∪R_{T(n)-1} and R₁ ∩Rⱼ=ϕ if i≠j, whether a PDM accepts an input X is determined in O(nT(n)) time complexity by checking each of the O(T(n)) trichoices in R₀, R₁, . . . , R_{T(n)-1} for an accepting state in Q_{f}.

### Advantageous Effects of Invention

The present invention has, but not limited to, the following advantages over the existing apparatuses or methods:
1. The present invention is more efficient in time complexity than any existing method or embodiment. The method, for the simulation of a PDM on an input X of length n, is of time complexity O(nT(n)).
2. The present invention avoids the technical difficulty using nondeterministic physical components, like quantum computing. The present invention takes the advantage of the deterministic position h(t, X) of a PDM at time t on input X.
3. The present invention, especially the disclosed deterministic methods for simulating a PDM on an input X, is easy to implement by use of existing experience and available deterministic components. For example relation R can be implemented as a relational database table and the methods can be embodied as SQL queries using a digital computer. The present invention is economical to build in mass production in hardware and/or software and thus can optimize time and resources. Without limiting, an existing general-purpose computer may be reused for the implementation of the present invention. New computer architecture may make best use of the present invention.
4. The present invention can employ high performance CPU for parallel processing and can employ network or a cloud for distributed processing for better performance.

### DESCRIPTION OF DRAWINGS

The following drawings are exemplary for illustrating the present invention. However, the present invention is not limited to the specific methods or instrumentalities disclosed. In the drawings:

FIG. 1 is a block diagram of an exemplary nondeterministic computing apparatus in which aspects of the present invention may be implemented.

FIG. 2 is a block diagram of the nondeterministic computing components according to one embodiment of the invention.

### MODE FOR INVENTION

### Exemplary Nondeterministic Computing Apparatus

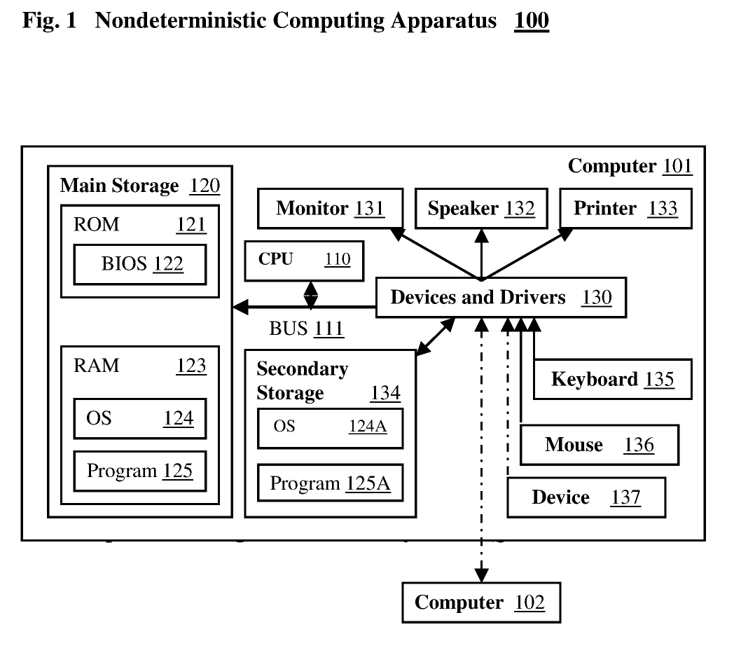

FIG. 1 shows an exemplary nondeterministic computing apparatus 100, which consists of a computer 101 and/or another computer 102 as deterministic computing apparatuses and aspects of the present invention implemented. The nondeterministic computing apparatus 100 is only an example of suitable nondeterministic computing apparatus and it is not intend to suggest any limitation as to any aspect of the present invention. The present invention may be implemented by use of, but not limited to, an electronic computer, an optical computer, a DNA computer, or a quantum computer, or any kind of digital computer, or a combination of some of them.

The present invention may be implemented in general context as software, such as in, but not limited to, shared library form or executable form in a computer system. The present invention may be implemented in general context as a dedicated hardware, such as, but not limited to, a circuit, a firmware, or a device with a driver (for example like device 137). The present invention may be implemented as a combination of software and hardware to fulfill the functionality of the present invention. The present invention may be implemented in parallel or over a network where the functionality of the present invention is distributed across two or more CPU's, such as in, but not limited to, computer 101 and computer 102.

With reference to FIG. 1, an exemplary nondeterministic computing apparatus 100 is illustrated. In it, computer 101 and 102 are composed of CPU 110, main storage 120, optional devices and drivers 130, and bus 111 which connecting them together, but not limited to, as shown. Devices and Drivers 130 further are optionally includes a monitor 131, a speaker 132, a printer 133, a secondary storage 134, a keyboard 135, a mouse 136; and, one or more other devices 137 (for example a digital camera) and one or more other computers 102, connected by, but not limited to, network interface or direct link. The main storage includes nonvolatile ROM 121 and volatile RAM 123. In addition to BIOS 122, an embodiment of the invention may be embodied inside ROM 121 and/or RAM 123. The nonvolatile secondary storage 134 further includes, but not limited to, OS 124A and one or more program 125A, which may include an embodiment of the invention, as a part or a whole of the present invention. Loaded OS 124 is either a part or the whole of OS 124A. Loaded program 125 is either a part or the whole of program 125A.

### Nondeterministic Computing Component

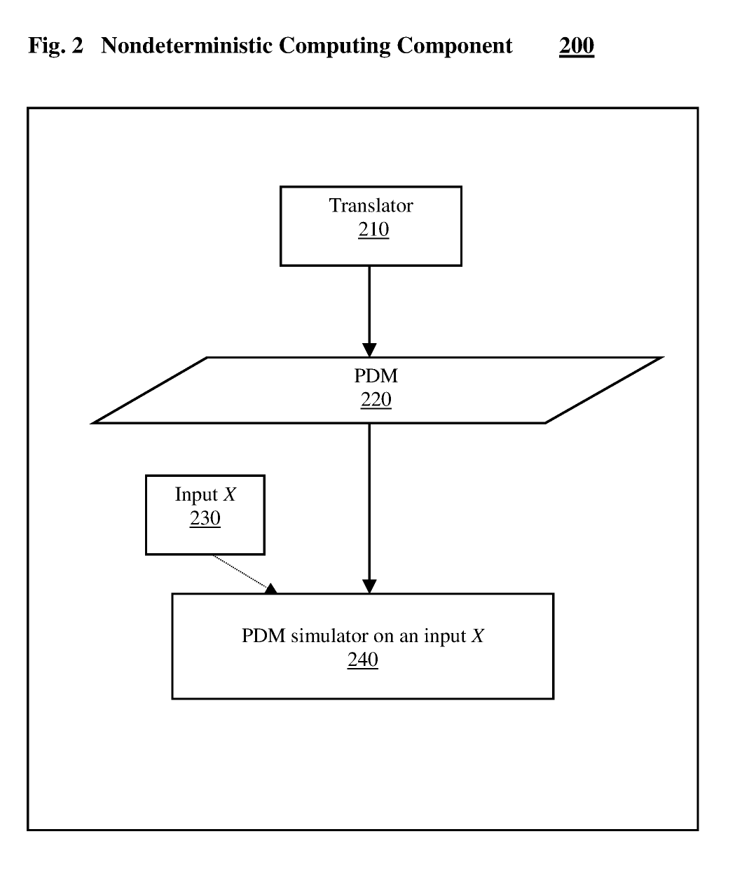

With reference to FIG. 2, according to one embodiment of the present invention, nondeterministic computing component 200 composing:
One or more translator 210 translating other nondeterministic Turing machines or equivalent nondeterministic computation representations in high-level language(s) into the format of PDM 220;
An input 230 to PDM 220;
A PDM 220 in the format in the present invention disclosed herein;
A PDM simulator 240 for PDM 220 and its input 230. The PDM simulator 240 simulates a PDA on an input X according to the methods disclosed herein.

### CITATION LIST

US Patents Referenced (with keywords in bold for easy patent search)

| Number | Inventor | Year | Title |
|---|---|---|---|
| 6,463,422 | Hangartner | 2002 | Probabilistic computing methods and apparatus |
| 7,400,282 | Tanaka, et al. | 2008 | Quantum Turing machine |
| 7,130,093 | Dolev, et al. | 2006 | Optical implementation of bounded non- |
| | | | deterministic Turing Machines |
| 5,843,661 | Rothemund | 1998 | Method for construction universal DNA based |
| | | | molecular Turing machine |
| 6,266,569 | Shapiro, et al. | 2001 | Method and system of computing similar to a |
| | | | Turing machine |
| 7,577,625 | Zhang | 2009 | Handling of satisfaction and conflicts in a |
| | | | quantified Boolean formula solver |
| 7,992,113 | Goldberg | 2011 | Methods and apparatus for decision making in |
| | | | resolution based SAT solvers |
| 7,860,814 | Plotnick | 2010 | System and method for providing a user-selected |
| | | | best solution to an NP-complete scheduling problem |
| 5,678,055 | Noro | 1997 | Method and device for generating Grobner bases to |
| | | | reduce memory usage and increase computing speed |
| 8,577,825 | Clayton | 2013 | System, Method and Device for Solving Problems in |
| B2 | Gilespie | | NP without Hyper-polynomial Cost |

### OTHER REFERENCES

Aho, A. V., Hoperoft J. E. and Ullman J. D. 1974. The Design and Analysis of Computer Algorithms, Addison-Wesley.
Codd, E. F. 1970. “A Relational Model of Data for Large Shared Data Banks”. CACM 13 (6): 377-387.
Cook, S. A. 1971. “The Complexity of Theorem Proving Procedures”. STOC 1971, 151-158. Cox, D., J. Little and D. O'shea. 2007. IDEAS, VARIETIES, AND ALGORITHMS—An
Introduction to Computational Algebraic Geometry and Commutative Algebra, Springer Fortnow, L. 2009. “The Status of The P versus NP Problem”. CACM, Vol. 52, No. 9, 78-86. Gödel K. 1931. “On formally undecidable propositions of Principia Mathematica and related systems” in J. von Heijenoort (ed.), From Frege to Gödel, Harward University Press, page 596-617, 1967
Li A. [2017]: The Recursive Relational Model of Computations and its Application to NP Problems, submitted to Science Advances (available upon request from the present inventor).

1. A nondeterministic computing apparatus, composing of one or more embodiments of position-deterministic machines.

2. The said position-deterministic machine (PDM) of claim [1] has the following characteristics to distinguish it from otherwise a nonphysical or inefficient nondeterministic Turing machine:
The said PDM has one or more finite volumes of memories and/or storages; and
The said PDM is specified nondeterministically but it is simulated deterministically; and
At any time t on an input X, each of the said volume's read and/or write position is determined by a respective function h(t, X) of value in one or more dimensions.

3. A time series of relations R₀, R₁, . . . , Rₜ, or any of their variants by reordering, or by regrouping, or by normalization, or by denormalization, in any form or in any combination, to store and/or calculate the computations for a PDM on an input X, with each Rᵢ, for 0<=i<=t, composing of all the trichoices (c_{w(i,X)}, cᵢ₋₁, cᵢ) taken from all valid sequences of extended choices, i.e. computations, in form of c₀ c₁ . . . cᵢ, in which an extended choice cᵢ is at least composing of a choice's selection time i and a choice, with each choice is at least composing of a next state and a next symbol to write; as disclosed in one embodiment of the present invention. The last time before time t, when reading and/or writing occurred at position h(t, X), was w(t, X), which is the maximal value j such that j<t and h(j, X)=h(t, X). The time starts, but not limited to, at 0; with an increment, but not limited to, by 1.

5. A deterministic method for the calculation of relation Rₜ₊₁ recursively from a portion of R₀, R₁, . . . , Rₜ or from any of the said variants by iterating each enclosed extended choice cₜ in Rₜ and using w(t+1, X) to find the symbol or the symbols to be read at time t+1 by the said PDM in the state enclosed in cₜ on a given input X; as disclosed in one embodiment of the present invention.

6. A deterministic method for deleting, from a portion of R₀, R₁, . . . , Rₜ or from any of the said variants, enclosed choices not occurring in any valid sequence of extended choices c₀ c₁ . . . cₜ satisfying (c_{w(i,X)}, cᵢ₋₁, cᵢ)∈Rᵢ for all 0<=i<=t, by deleting those enclosed extended choices with maximal time iteratively using r(i, X), for a said PDM on a given input X; as disclosed in one embodiment of the present invention. The next time after time t, when reading and/or writing will occur at position h(t, X), will be r(t, X), which is the minimal value j such that j>t and h(j, X)=h(t, X).
